(19) United States
(12) Patent Application Publication
(10) Pub. No.: US 2020/0306989 A1
(43) Pub. Date: Oct. 1, 2020

(54) MAGNETOMETER FOR ROBOT NAVIGATION

(71) Applicant: Robart GmbH, Linz (AT)

(72) Inventors: Reinhard Vogel, Linz (AT); Harold Artes, Linz (AT); Dominik Seethaler, Linz (AT); Daniel Bartel, Linz (AT)

(73) Assignee: Robart GmbH, Linz (AT)

(21) Appl. No.: 16/634,790

(22) PCT Filed: Jul. 27, 2018
(86) PCT No.: PCT/EP2018/070425

§ 371 Date: Jun. 23, 2020

(30) Foreign Application Priority Data
Jul. 28, 2017 (DE) 10 2017 117 148.7

(51) Int. Cl. B25J 13/08; B25J 9/16; B25J 11/00

(52) U.S. Cl. CPC B25J 13/089; B25J 9/161; B25J 9/1653; B25J 5/007; B25J 9/1661; B25J 9/1664; B25J 11/0085

(57) ABSTRACT

Methods for an autonomous mobile robot are described. According to an exemplary embodiment, one method comprises the detection of information regarding the structure of the environment around the robot in the robot deployment area by means of a first sensor unit of the robot and the creation of a map based on the detected information. The method also comprises the measurement of a direction and/or a quantity of at least one physical vector field variable for one or more poses of the robot by means of a second sensor unit and the determination, based on the measurement(s) carried out for one or more poses of the robot, of a preferred direction of the at least one physical vector field variable for the robot deployment area (or a portion thereof). Furthermore, corresponding robots and robot systems are described.

### TECHNICAL FIELD

The invention relates to an autonomous mobile robot such as a service robot for treating a surface (e.g. cleaning floors), for communicating, transporting or for monitoring and inspecting an area, in particular a system consisting of an autonomous mobile robot and a human-machine interface for displaying the map data used by the robot.

### BACKGROUND

In recent years, autonomous mobile robots, especially service robots, have become increasingly common in private households. Possible applications include cleaning robots for cleaning a floor surface, surveillance robots to detect possible hazards such as burglars or fires during patrols, telepresence robots which facilitate communication between humans over long distances regardless of their location and activity, and assistance robots which help people transport objects, for example.

In this context, systems are increasingly being used to map the environment (i.e., the robot deployment area) for targeted navigation using a SLAM algorithm (Simultaneous Localization and Mapping, see e.g., H. Durrant-Whyte, T. Bailey: Simultaneous Localization and Mapping (SLAM): Part I The Essential Algorithms, in: IEEE Robotics and Automation Magazine, Vol. 13, No. 2, p. 99-110, June 2006). Herein, a map and the position (which generally also includes the orientation, in which case it often is referred to as “pose”) of the robot in the map is determined by means of different sensors (e.g., laser range scanner, camera, tactile (touch) sensors, odometers, accelerometers, etc.).

The map created in the aforementioned manner can be stored permanently and used for subsequent deployments of the robot. By (re-)using stored maps, for example, user interactions can be simplified by making it possible for the user to send the robot to a specific location to perform a task, such as cleaning the living room. In addition, the robot's workflow can be made more efficient, as the robot can plan ahead using the “prior knowledge” of its deployment area (i.e., based on the information stored in the map).

An important prerequisite for the robot's reuse of a map is the ability of the robot to perform a (global) self-localization. This allows the robot to reliably determine its pose (i.e., position incl. orientation) in the map (again), if this information has been lost, for example, after a reset or a repositioning by the user. It can be helpful in this context if the robot has additional information about its orientation in this map. For example, in an exactly square space, a clear determination of the pose of the robot is only possible if the robot has additional information about its (approximate) orientation. It can also be helpful for a user if further information is displayed in addition to the map required for robot navigation, which makes it easier to orient himself/herself in the map. The inventors have therefore made it their object to create a robot capable of easily determining its orientation in relation to a previously created map of the robot deployment area. Another object is the improvement of the robot navigation by means of measurements of magnetic fields.

### SUMMARY

The aforementioned object is solved by the methods according to claims 1, 20 and 34, by the robot according to claim 5 and the systems according to claims 16 and 30. Various exemplary embodiments and further developments are the subject matter of the dependent claims. Methods for an autonomous mobile robot are described in the following. According to an exemplary embodiment, one method comprises the following: detecting information regarding the structure of the environment around the robot in the robot deployment area by means of a first sensor unit of the robot and creating a map based on the detected information. The method also comprises the measurement of a direction and/or an absolute value of at least one physical vector field variable for one or more poses of the robot by means of a second sensor unit and the determination, based on the measurement(s) carried out for one or more poses of the robot, of a preferred direction of the at least one physical vector field variable for the robot deployment area (or a portion thereof).

According to another exemplary embodiment, the method involves transferring a first map of a robot deployment area to an autonomous mobile robot, detecting information about the structure of the environment in the robot deployment area using a sensor unit of the robot, and creating a second map of the robot's deployment area (or a part thereof), by means of which the robot can navigate the robot deployment area, based on the detected information regarding the structure of the environment and the first map.

Another exemplary embodiment relates to docking to a base station. Accordingly, the method comprises navigating the robot to a position near the base station according to a position/pose of the base station entered in a map (e.g., by means of information detected by a sensor unit regarding a structure of the robot's environment in the robot deployment area), as well as detecting a current pose of the base station relative to the robot (e.g., by means of the sensor unit). The procedure also comprises planning a path for a docking maneuver to the base station and performing the docking maneuver. A magnetic field generated by at least one magnet generated at the base station is measured, whereby the docking maneuver can be monitored based on the measured magnetic field.

Furthermore, an autonomous mobile robot is described. According to an exemplary embodiment, the robot has a drive unit for moving/navigating the robot within a robot deployment area. In addition, the robot has a first sensor unit for detecting information about the structure of the robot's environment in the robot deployment area, as well as a second sensor unit for measuring a direction and/or an absolute value of at least one physical vector field variable at one or more poses of the robot. A control unit is designed for moving/navigating the robot in the robot deployment area based on the information provided by the first sensor unit about the structure of the environment in the robot deployment area and a map of the robot deployment area, and to determine, based on the measurements of the at least one physical vector field variable performed with the second sensor unit at one or more poses of the robot, a preferred direction of said poses in the robot deployment area (or in a part of it).

Furthermore, systems with an autonomous mobile robot and another external (to the robot) electronic device are also described. According to an exemplary embodiment, the robot has a communication unit and is designed to communicate with the electronic device by means of the communication unit. The electronic device is designed to receive from the robot the map of the robot deployment area as well as the preferred direction associated with it.

Furthermore, systems with an autonomous mobile robot and a base station are described. According to an exemplary embodiment, the base station is designed to generate a defined magnetic field, and the robot is designed to recognize the base station with the help of at least a first sensor unit and to perform a docking maneuver based on this recognition. For this purpose, the robot has a second sensor unit with a sensor to measure the magnetic field.

### BRIEF DESCRIPTION OF THE DRAWINGS

The invention is explained in more detail below on the basis of the examples shown in the drawings. The representations are not necessarily true to scale, and the invention is not limited to the aspects presented therein. Rather, the drawings are intended to illustrate the principles underlying the invention. The drawings show:

FIG. 1 An example of a robot deployment area and a current position of the robot in the deployment area

FIG. 2 A block diagram which schematically represents the functional units and assemblies of an autonomous mobile robot

FIG. 3 Different options for measuring an external magnetic field (geomagnetic field), wherein interference fields can be compensated for

FIG. 4 The different orientation of a map determined by the robot at different initial positions of the robot

FIG. 5 The orientation of a map determined by the robot using a preferred direction of the magnetic field in the robot deployment area determined by the robot

FIG. 6 The representation of a robot map on an HMI, taking into consideration the preferred direction determined by the robot for the map

FIG. 7 The process for avoiding ambiguous solutions when the robot determines its preferred direction during self-localization

FIG. 8 Merging a map of a dwelling with a robot map

FIG. 9 The influence of the sensors used for mapping on the maps of the robot deployment area determined by the robot

FIG. 10 The automated transfer of information from a robot map to a newly created robot map

FIG. 11 A base station for an autonomous mobile robot and the use of magnetic fields for docking the robot to the base station

FIG. 12 A flow diagram for illustrating the procedure during a docking maneuver to a base station, wherein the docking path is corrected by means of magnetic field measurements

### DETAILED DESCRIPTION

An autonomous mobile robot as a service robot generally can perform one or more tasks autonomously during a deployment, such as cleaning or monitoring a robot deployment area or transporting objects within the robot deployment area. For example, the robot deployment area can be an apartment, a house or an office space. The exemplary embodiments described below mostly relate to cleaning robots. However, the present invention is not limited to the use for cleaning robots, but is applicable to all conceivable applications in connection with autonomous mobile robots, in which one or more autonomous mobile robots are to perform one or more tasks in a defined deployment area, in which they can move independently (e.g., navigate) by means of a map.

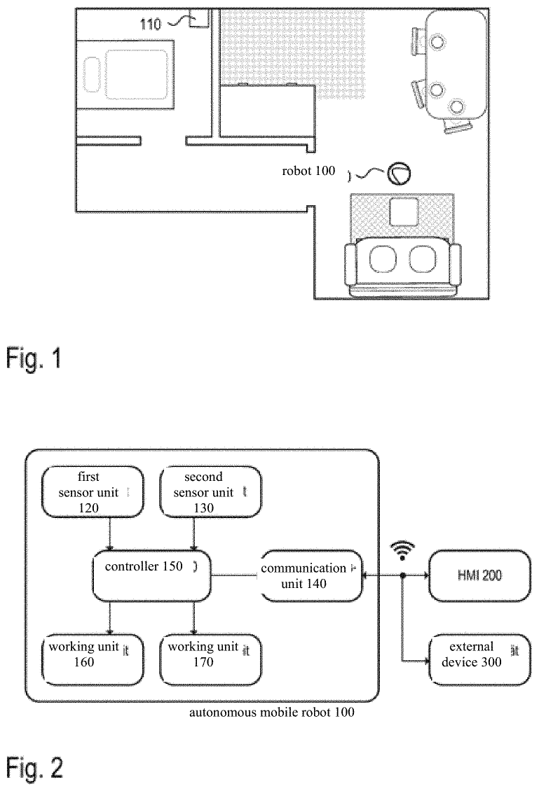

FIG. 1 shows an example of a deployment area for an autonomous mobile robot 100 as well as its current position (incl. orientation) within the deployment area. The deployment area is, for example, a dwelling with multiple rooms. In order to enable autonomous operation without a great number of interactions with the user, a base station 110 may be present at a location within the deployment area. The autonomous mobile robot 100 can return to the base station after completing a task. A battery of the autonomous mobile robot 100 can be charged at the base station, for example. In the case of cleaning robots, such as a robot vacuum, the dirt picked up during a cleaning run can also be disposed of at the base station 110. In the case of robot mops, cleaning agents to be applied to the floor surface can be replenished at the base station 110, for example. However, these are just examples. All activities that are required after or during the use of the autonomous mobile robot 100 can be performed at the base station 110. The robot 100 is designed to navigate independently during a deployment, on the basis of a map of the robot deployment area. Depending on the type of robot 100, it can also be used without a base station.

FIG. 2 shows a block diagram of the different units of an autonomous mobile robot 100 by way of example. Herein, a unit can be a stand-alone unit and/or a part of a software for controlling the robot performing the task described therein. The software responsible for the behavior of the robot 100 can be executed on the control unit 150 of the robot 100 (by means of the corresponding processor and memory element) or can be at least partially outsourced to an external computer, which is accessible, for example, in a home network or via the Internet (cloud server).

In the exemplary embodiments described here, the autonomous mobile robot 100 comprises a drive unit 170, which can have, for example, electric motors, gears and wheels, whereby the robot 100 can—at least theoretically—reach any point of its deployment area (unless access to a location is blocked by an obstacle).

The autonomous mobile robot 100 also comprises a communication unit 140 for establishing a communication connection to a human-machine interface (HMI) 200 and/or other external devices 300. For example, the communication connection can be a direct wireless connection (e.g., Bluetooth), a local wireless network connection (e.g., Wi-Fi or ZigBee), or an Internet connection (e.g., via a cloud service).

The aforementioned human-machine interface 200 can be used to output information about the autonomous mobile robot 100 to a user (e.g., battery status, current work order, map information such as a cleaning map, etc.) as well as receive user commands. For example, a specific user command can represent an assignment to the autonomous robot to perform a specific task in a particular area. Examples of a human-machine interface 200 are tablet PC, smartphone, smartwatch, computer, smart TV, or head-mounted displays. In some cases, a human-machine interface is directly integrated into the robot and can be operated via buttons and/or gestures. Alternatively or additionally, the human-machine interface can make possible the control and monitoring of the robot via voice input and output. Examples of external devices 300 are computers and servers on which calculations are performed and/or data are stored, external sensors providing additional information, or other household appliances (e.g., other robots), with which the autonomous mobile robot 100 collaborates and/or exchanges information.

In the exemplary embodiments described here, the autonomous mobile robot 100 has a control unit 150 which provides all the functions that the robot needs to move independently in its deployment area and perform a task. At least parts of the functions of the control unit 150 can be implemented by means of software. For this purpose, the control unit 150 comprises, for example, a processor and a memory module to execute a control software 151 of the robot 100. The control unit 150 generates control commands (e.g., control signals) for the working unit 160 and the drive unit 170 based on the information received from sensors (e.g., sensors 120, 130) and the communication unit 140. The control software 151 can include functions for object recognition (e.g., based on information from the sensors) and task planning (e.g., based on information coming from the user via the communication unit 140). In order for the robot to perform a task autonomously, the control software 151 comprises a navigation module. This makes it possible for the robot to orient itself by its environment, for example, by means of navigation features such as landmarks, which are detected by means of the first sensor module 120, and to navigate accordingly. For example, the navigation module operates with an obstacle avoidance strategy, a SLAM algorithm (simultaneous localization and mapping) and/or one or more maps of the robot deployment area. The navigation module is at least partially implemented as software and can be executed on the aforementioned processor of the control unit 150, for example.

The robot can create new maps of the robot deployment area during a deployment or use a map that already exists at the beginning of the deployment. An existing map may have been created by the robot itself during a previous deployment (for example, an exploration run), or may have been made available by another robot and/or a user. For example, the existing map can be stored permanently in a memory module, such that it can be reused during a subsequent robot deployment. Alternatively, the maps of the robot deployment area to be stored permanently can also be stored outside of the robot, for example on a computer in the household of the user of the robot (e.g., tablet PC, home server) or on a computer accessible via the Internet (e.g., a cloud server).

In those exemplary embodiments in which the robot is intended to perform an activity such as cleaning a floor surface, the autonomous mobile robot 100 can have a working unit 160. In the aforementioned example, this is a cleaning unit for cleaning a floor surface (e.g., brush, suction device, mop, wet cleaning device) or a gripping arm for grasping and transporting objects. In some cases, such as in a telepresence robot or a surveillance robot, another assembly is used to perform the intended tasks and no working unit 160 is required. For example, a telepresence robot can have a communication unit 140 coupled with a human-machine interface 200 with a multimedia unit, which includes, for example, a microphone, camera and screen, to make possible a communication between several persons located great distances apart from each other. A surveillance robot uses its sensors to detect unusual events (e.g., fire, light, unauthorized persons, etc.) during surveillance runs and, for example, informs a control point about such events.

The autonomous mobile robot 100 includes numerous sensors. In particular, it has a first sensor unit 120 for detecting information about the (geometric) structure of the robot's environment, such as the position of obstacles, their spatial expansion or other navigation features in the robot deployment area. The first sensor unit 120 comprises, for example, a sensor for measuring distances to objects in the environment, such as an optical and/or acoustic sensor, which works by means of triangulation or runtime measurement of an emitted signal (triangulation sensor, time-of-flight camera, laser scanner, ultrasonic sensors). Other typical examples of suitable sensors are cameras and tactile sensors. Other typical sensors used in autonomous mobile robots include sensors to determine the speed of and/or distance traveled by the robot, such as odometers and gyroscope sensors. The use of these sensors for controlling an autonomous mobile robot 100 and in particular for navigating and mapping is known in principle.

In the exemplary embodiments described here, the robot has a second sensor unit 130 for measuring the direction and/or the absolute value of at least one physical vector field variable at the position of the robot. For example, accelerometers can be used to determine the direction (relative to the robot) and the absolute value of the Earth's gravitational field as long as the robot is at rest or moving uniformly. Magnetic fields such as, in particular, the geomagnetic field can be determined with magnetometers such as Hall effect sensors.

For many applications for controlling an autonomous mobile robot 100, it is advantageous to know an approximate orientation regarding a map previously captured by the robot 100. For example, a suitable orientation of a graphical display of the map data on a human-machine interface (e.g., smartphone, tablet PC) can make it easier for a user to orientate himself/herself when viewing the map. Another application is (global) self-localization, in which the position (and orientation) of the robot in a previously recorded map is determined without (or with only limited) prior knowledge, for example by matching current sensor data with the map data. A third application is the evaluation of map information predefined to the robot. If the approximate orientation of the robot relative to the map (or the environment) can be determined without much effort, this degree of freedom (i.e., the orientation of the robot in relation to the map) can be limited to a possible solution space. This can reduce the computational effort involved in global self-localization.

The term “approximate orientation” refers to a measurement value for the orientation, which may contain a larger (measurement) error (e.g., up to ±5°, 10°, 25°). The accuracy of the “approximate orientation” can therefore be significantly worse than, for example, the accuracy with which the robot must determine its actual orientation in order to navigate properly or to generate maps (e.g., by means of SLAM).

Autonomous mobile robots 100, which move around in their environment and orient themselves by means of sensors and map data stored in a map, are known in principle. For robots in outdoor use, such as mowing robots or other self-propelled agricultural machinery, magnetometers can be used to measure the geomagnetic field to determine a fixed orientation in space. This is used, for example, to ensure straight and parallel treatment lines (e.g., when mowing a lawn).

Inside buildings, a measurement of the geomagnetic field is usually not possible with sufficient accuracy, since in particular structural elements containing iron (e.g., steel-reinforced concrete) as well as electrical currents result in magnetic interference fields, which significantly overlay the natural geomagnetic field. These interference fields are so strong and characteristic that the modification of the magnetic field could be used to create maps and orient the robot using SLAM (vector field SLAM) procedures. In a home environment, however, this method is unsuitable to create a permanent map for the orientation of the robot, since the magnetic interference fields are easily modified by the behavior of the inhabitants, for example by (de-) activating an electrical device or moving a chair with metal legs or other metallic objects, etc.

For the reasons listed above, it is generally assumed that the measurement of a magnetic field (especially of the geomagnetic field) in a home environment does not provide valuable information for controlling an autonomous mobile robot. The only known application of magnetic fields for controlling robots in a home environment is as an external marker. For example, magnetic strips can be laid out or glued on a floor surface to mark a boundary that the robot must not cross.

In the exemplary embodiments described here, the preferred direction of a physical vector field variable such as the magnetic field within an area represented by a map is determined in order to complement the conventional navigation of an autonomous mobile robot with a navigation sensor (e.g., one included in sensor unit 120 such as a sensor for distance measurement or a camera) and thus simplify the navigation. This preferred direction corresponds, for example, to an expected orientation of the magnetic field in space, which is usually determined primarily by the geomagnetic field, which, however, may be overlaid by interference fields. Herein, no local measurement is used, as this is not representative due to the previously described interference fields. Rather, the vector field variable is determined, for example, at several positions and/or orientations (poses) of the robot in the deployment area. From these individual measurements, a representative and easily reproducible value for the preferred direction can be determined for the deployment area. For example, the value of the preferred direction can be determined from the cluster of individual measurement values by means of statistical evaluation (e.g., calculation of the modal value, median or mean value, etc.).

The magnetic field can be measured in all three spatial directions (i.e., in three dimensions). In order to determine a preferred direction for the magnetic field in a robot deployment area (and in a corresponding map), the three-dimensional measurement values can be used, or the measurement values can be projected onto a plane parallel to the floor surface. Alternatively, a sensor can be used, which detects only the magnetic field strength in one or two dimensions which extend parallel to the floor surface. Essentially, the north-south orientation of the magnetic field is determined herein. It should be noted that rotating (changing the orientation) a robot having a sensor that detects the component of the magnetic field in only one direction (e.g., a Hall effect sensor) results in the magnetic field being detected in two spatial directions (before and after rotation). By adding a sensor for measuring the third spatial direction, the three-dimensional magnetic field can be detected.

As noted above, the magnetic field to be measured is not constant in a robot deployment area (especially within buildings, such as in a home environment). Therefore, according to the exemplary embodiments described here, the magnetic field is measured at different positions and orientations of the robot 100 in order to determine a preferred direction based on this plurality of measurement values. In the simplest case, a mean value is formed (e.g., arithmetically) for this purpose. Preferably, the measurement values of the magnetic field for determining the preferred direction are selected and/or weighted depending on the position and orientation of the robot. Interferences in the magnetic field in home environments can be caused, for example, by obstacles such as furniture or walls (e.g., due to the electrical installation in them or due to components containing iron). Therefore, those (or only those) measurement values can be selected for determining the preferred direction which are determined at a predefinable (minimum) distance from an obstacle, for example.

In addition, it is possible to determine how much the measurement values vary spatially. Thus, a constant measurement signal in all directions indicates an undisturbed magnetic field, whereas a spatially changing magnetic field is a result of interference fields. Consequently, spatially constant measurement signals are preferably used for determining the preferred direction. For this purpose, the magnetic field is measured at two positions with a predetermined distance (e.g., 1 cm, 5 cm) when the robot is moving, for example, and the two measurement values are compared with each other. In the case of widely differing measurement values, these measurement values can be ignored for the calculation of the preferred direction. Statistical outliers can be ignored. In particular, the absolute value and the three-dimensional orientation of the magnetic field can be taken into consideration in order to identify interferences. The geomagnetic field has a characteristic intensity and orientation with regard to the earth's gravitational pull depending on the geographical position. In addition, a magnetic field changing over time may indicate an external interferences. Based on the magnetic field measurements conducted at different positions (and at different orientations) of the robot, the robot can, for example, generate a magnetic field map. This can, for example, be a grid map in which one or more measurement values are stored for each element of the grid. Alternatively, the measurement values together with the associated poses (position and orientation) of the robot can be stored as a representations for the magnetic field map.

In addition to the determined preferred direction, degrees of its accuracy can be determined. In addition, it can be determined which distance and/or area the robot must cover in order to achieve this accuracy. The simplest measure of the accuracy of the preferred direction is the standard deviation of the preferred direction based on the already captured measurement positions. Another possibility is to determine the area proportion of the total area accessible to the robot 100, in which the direction of the measurable magnetic field corresponds to the (previously determined) preferred direction with a predefinable accuracy (e.g. ±5°, ±10°, ±25°, etc.). As mentioned above, the preferred direction can be determined by statistical evaluation of the individual measurements, for example by forming a mean value.

According to a further approach, the robot continuously detects measurement values for the magnetic field at different positions as it moves through the robot deployment area. After receiving a new measurement value, the preferred direction can be updated. For example, with each additional measurement, the mean of all measurement values becomes more accurate as an estimate of the actual value. The variance of the mean becomes smaller. Furthermore, the distance that a robot travels until it has determined the preferred direction with a desired accuracy can also be used as a measure of accuracy. If the measurements are repeated at a later time, the robot already “knows” how far it must move while measuring to achieve a desired accuracy. The robot can be designed to determine that the interference fields are so strong and inhomogeneous that no preferred direction can be determined.

The robot may be set up to divide its deployment area into several sections and to determine a separate preferred direction for each of the sections. The sections can, for example, be rooms of a dwelling or parts thereof. Alternatively or additionally, the sections can be a fixed area of a predefinable size.

In addition to the external interference fields, there are internal interference fields, which are caused by the robot 100 itself. These can be determined and compensated for by calibration, for example. A first source of internal interference fields are magnetic fields that are caused in the robot, such as magnetic fields occurring during the operation of electric motors or magnetic fields caused by permanent magnets in the robot. These provide a constant contribution to the measured magnetic field, which contribution moves (and rotates) along with the robot (hard iron distortions). The constant magnetic interference fields are compensated for by an offset (fixed relative to the robot), which is dependent on the activity of the robot and in particular the electrical currents used by individual actuators (e.g., motors of the drive unit or the working unit) in each case.

A second source of interference are magnetizable (ferromagnetic) components of the robot, which lead to a distortion of the external magnetic field, which depends on the orientation of the robot (soft iron distortions). This can be compensated for by a linear projection (transformation matrix) that is constant with respect to a coordinate system which is fixed relative to the robot. This can be determined, for example, by measurements conducted by the robot of a constant external magnetic field in different orientations of the robot. Such a compensation (calibration of the magnetic field sensor) is known in principle and is used in electronic compasses, for example. If, for example, the robot were to rotate at a fixed position about its own vertical axis, the robot would “see” a magnetic field vector rotating along a circle (in the coordinate system fixed relative to the robot). However, due to interferences, this circle is actually an ellipse. The aforementioned transformation matrix maps the ellipse to the circle, which compensates for the interference.

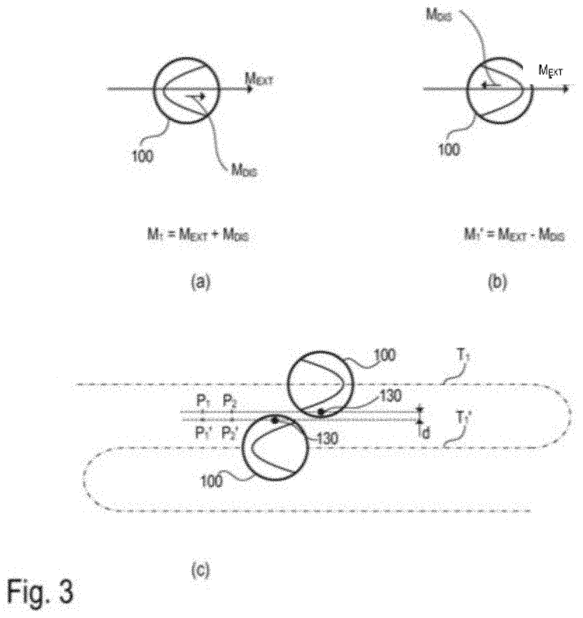

One way to compensate for the magnetic interference fields caused by the activity of the robot (first source) is to measure the magnetic field at a fixed position with opposite orientation. For this purpose, the robot can rotate in one place, for example. The mean of both measurements (in the global coordinate system of the robot's map) results in a measurement of the external magnetic field Mₑₓₜ (e.g., the geomagnetic field), which is independent of the (interference) magnetic field Mats caused by the robot. This situation is represented in the diagrams (a) and (b) of FIG. 3. In the case shown in diagram (a), the robot 100 “sees” the magnetic field M₁=Mₑₓₜ+M_{dis}. In the case of a rotation by 180°, the interference field M_{dis} caused by the robot itself rotates along with the robot 100, whereas the external magnetic field Mₑₓₜ remains constant (see FIG. 3, diagram (b)). In this case, the robot 100 sees the magnetic field M₁′Mₑₓₜ−M_{dis}. The mean (M₁+M₁′)/2 corresponds exactly to the external field Mₑₓₜ. For a person skilled in the art, the second dimension in the movement plane of the robot can be determined in an analogous manner. The third dimension, which is perpendicular to the movement plane, can be ignored. Alternatively or additionally, a complete calibration can be performed during the production of the robot.

Another option depends on the activity of the robot. For example, cleaning robots clean a floor surface in parallel, adjacent (or slightly overlapping) tracks. This situation is represented in the diagram (c) of FIG. 3. Here, two directly adjacent, parallel tracks T₁,T₁′ are traveled on in opposite orientations. The combination of measurements at least two positions P₁ and P₁′, P₂ and P₂′, etc., with as little distance d between them as possible can thus be used as an approximation to a measurement at a fixed point with opposite orientation. Therein, care can be taken to ensure that the distance between the two measuring positions does not exceed a predefinable maximum value (e.g., 15 cm, 10 cm or 5 cm). If the magnetometer is mounted in the center of a cleaning track, the usual distance of two measuring positions with opposite orientation approximately corresponds to the width of a cleaning track (e.g., 15 cm or 20 cm). If the magnetometer 130, as shown in diagram c of FIG. 3, is mounted offset to one side of the cleaning track, the distance d between two measuring positions with opposite orientation can be reduced.

Display of a map based on its preferred direction—In a preferred embodiment of the invention, the autonomous mobile robot 100 is designed to establish a communication connection to another electronic device such as a human-machine interface (HMI, e.g., tablet PC) or another robot. Thus, electronic maps representing at least one robot deployment area and the at least one preferred direction determined for a robot deployment area can be transmitted to the other device.

An HMI can display the map data to a user in graphic form and receive a user input based on the displayed map. For example, the map data can be displayed on a tablet PC with a touchscreen in the form of a floor plan of the robot deployment area, such as a dwelling. The user can give the robot an instruction such as cleaning a certain area, for example by marking it within the floor plan.

However, a map automatically generated by a robot is often difficult for a user to interpret, as the user usually cannot associate the orientation points determined by the robot directly with real objects (e.g., walls, doors, furniture, etc.) in the robot deployment area. For example, from the robot's “view,” a cabinet and a couch can appear as large rectangular obstacles in front of a wall and be displayed accordingly in a map. From a user's point of view, however, these are two very different objects. In addition, there are obstacles such as a table standing in the room that are relevant to the user, as he/she has to go around them, while such objects are no obstacle for the robot except for the comparatively small table legs. It is therefore necessary to establish a direct relationship between the representation of the map data and the real environment.

A situation in which interpreting the map data is intended to be made easier for a user is, for example, the time right after a new map is created by the robot. For example, automatic room recognition can be performed based on map data recorded by the robot during a learning run. However, this room recognition is not always reliable, such that the association of the map data with specific room features has to be edited by the user, which requires a good understanding of the displayed map data. To achieve this, both the output of the map data and the interpretation of the input of user instructions can be conducted based on the preferred direction determined by the robot.

In the case of currently commercially available cleaning robots, the robot's map data is newly created by the robot by means of its sensors each time the robot is deployed. The orientation of the graphical representation of the map data can be different for each deployment, which makes it difficult for a user to orientate himself/herself in this map. This can be simplified, for example, by determining the preferred direction based on the magnetic field and displaying the graphical representation of the map data with North at the top of the display. This means that the orientation of the display of the map data is the same for each use of the robot.

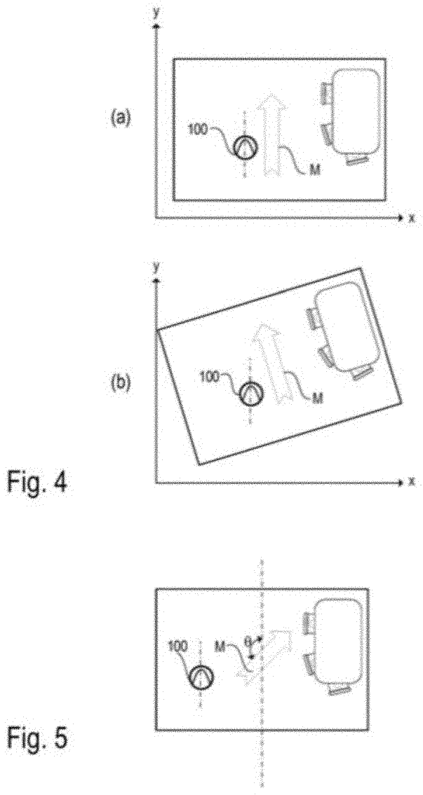

This problem is shown in FIG. 4. When the robot starts generating a map it does not yet have a “global” orientation characteristic (such as the knowledge that the room is oriented to the south), by means of which it can orient the map in a clearly defined way. The orientation of the robot 100 relative to the robot deployment area (e.g., a room of a house) is thus not always clearly defined at the beginning of the robot deployment and can therefore be chosen at will. In this example, it is assumed—without loss of generality—that the robot starts out with an orientation parallel to a y-direction. This means that the initial position of the robot and in particular its orientation (initial pose) can be established by the global, fixed-position coordinate system for describing the map data. In the example from diagram (a) of FIG. 3, for example, the robot starts out with an orientation parallel to a wall, and in the map determined by the robot, a wall then extends parallel to the y-direction. In the example from diagram (b) of FIG. 4 the robot starts out with a slightly different orientation, and the map determined by the robot accordingly is rotated compared to the situation in diagram (a). The arrow labeled M represents the preferred direction of the magnetic field that can be determined by the robot for the robot deployment area. The preferred direction M is a global orientation characteristic, which is (approximately) the same for each robot deployment in which a map is newly generated, and by means of which the map can be orientated. This is taken into consideration, for example, when determining the display of the map on an HMI. For example, the map can always be displayed such that North is at the top of the display. For example, regardless of the robot's initial pose, the map can always be displayed as shown in diagram (a) of FIG. 4. It should be noted that the processing of the robot's map data for display on an HMI, can be performed in the robot, in the HMI, on a server or any other computer, or in a combination of these. In particular, the preferred direction together with the map data intended to be displayed (in particular as part of the map) can be sent from the robot to the HMI or another external device via the communication interface.

In addition, it may be possible for the user to influence the orientation of the graphic representation of the map data. Herein, the HMI (see FIG. 2, HMI 200) can store the orientation chosen by the user with respect to the determined preferred direction. When new map data and a preferred direction are sent to the HMI during a further deployment of the robot, then the orientation of the graphical representation of the map data can be conducted based on the stored orientation with respect to the preferred direction. This makes it possible to always choose the orientation of the graphical representation of the map data according to the user's preference, which makes it easier for the user to navigate the displayed map, even if it is newly generated by the robot during each deployment. For example, the user could define an angle θ (e.g., for a specific robot deployment area), which represents the desired angular position of the map relative to the preferred direction M determined by the robot. This situation is represented in FIG. 5.

Assuming the preferred direction M points exactly South and the robot deployment area is actually oriented in a south-easterly direction, then an angle θ of 135° can be defined, and the map determined by the robot 100 is always rotated by this angle relative to the determined preferred direction M, at least for the purpose of being displayed on the HMI 200. In the present example, the south-east wall of the room would always be at the top of the map representation on the display of the HMI 200. For the examples described here, the preferred direction determined by the robot can be considered to be a characteristic/attribute of the robot deployment area or a section thereof. Storing the angle θ and/or orienting the map relative to the display of the HMI 200 can be performed from both the HMI 200 and the robot 100.

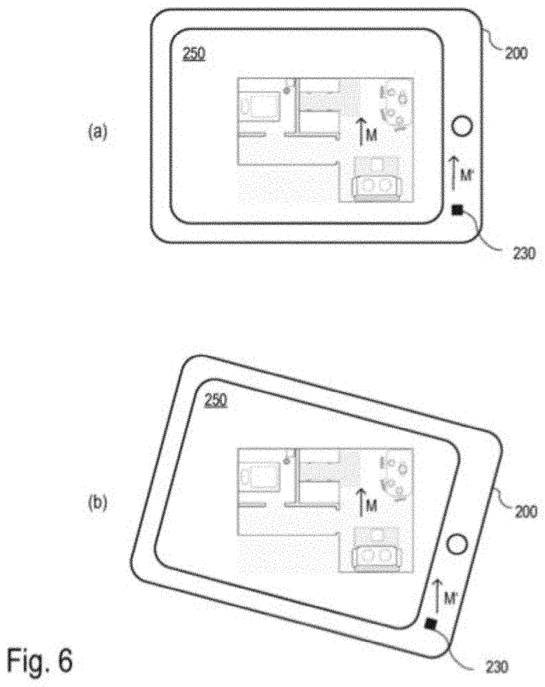

The comprehensibility of the graphical representation of the map data can be further increased if it can be displayed in accordance with the orientation of the real environment. This situation is represented in FIG. 6. For this purpose, an external electronic device (cf. FIG. 2, device 300 or HMI 200, e.g., a tablet PC), which receives the map data and the corresponding preferred direction M determined by the robot 100 from the robot 100, may also be designed to determine the preferred direction M′. For this purpose, it may have appropriate sensors such as a magnetometer, to measure the physical vector field variable (e.g., its direction), which the robot also has used to determine the preferred direction. In the example shown in FIG. 6, the HMI 200 has a sensor unit 230, which contains a magnetic field sensor, among other devices. In addition, the electronic device (e.g., HMI 200) can have sensors to determine its position or a change of position.

The HMI 200 may, for example, have a gyroscope and an accelerometer, which may also be included in the sensor unit 230, for example. The measurement values of these sensors can be used to calibrate the magnetometer. For example, a change in position (displacement and/or rotation) of the HMI 200 can be detected on the one hand by the fact that the orientation of the magnetic field changes (as seen from the HMI 200) relative to the HMI 200, and on the other hand by the fact that the gyroscope measures a rotation. The measurement values of both sensors (gyroscope and magnetometer) can be combined, for example for reviewing the plausibility of the magnetic field measurements or for calibrating the magnetometer.

For example, the electronic device has an HMI (e.g., tablet, smartphone, cf. FIG. 2, HMI 200) with a screen 250 for the graphical representation of the map data. This makes it possible to select the orientation of the graphical representation such that the preferred direction M determined by the robot with respect to the map data points in the preferred direction M′ (separately) determined by the HMI. This way, a floor plan of the robot deployment area (e.g., dwelling), for example, would be oriented such that it corresponds to the real dwelling. In addition, the display can be rotated when the HMI is rotated, such that the orientation of the representation is maintained relative to the real environment. The necessary corrections (rotation) of the representation of the map data can be determined based on the measurements of the magnetic field and/or on measurements of the rotation rate during the rotation of the HMI. This situation is represented in the diagrams (a) and (b) of FIG. 6. In diagram (b), the HMI 200 has been rotated in comparison to diagram (a). Based on the measurement of the preferred direction M′, the HMI 200 can adjust the representation of the robot map such that it remains correctly aligned with the preferred direction M′. The map display therefore stands still even when the HMI 200 is being rotated.

In addition, spatial changes of the magnetic field based on, for example, a movement of the electronic device recognized by the HMI 200 by means of the gyrosensor, can be detected and used to determine the preferred direction. For example, the external device is a smartphone or tablet PC and has a gyroscope and an accelerometer by means of which movements of the smartphone or tablet PC can be detected. A rotation of the smartphone or the tablet PC and the accordingly changed orientation of the smartphone or the tablet PC in relation to the preferred direction can be measured not only with the magnetometer but also with the gyroscope or the accelerometer. Furthermore, an appropriate (spatial) mean can be used to determine the preferred direction. Alternatively or additionally, a selection of the measurement values to be taken into consideration can be made. For example, it can be determined whether the measured magnetic field is spatially constant or highly varying, wherein spatially constant values would be preferred. Alternatively or additionally, the measurement values can be compared with a reference value and can only be taken into consideration if they match the reference with a predefinable accuracy. The reference can be the geomagnetic field, or a value determined by the robot as a reference. During the comparison, the absolute value of the measured magnetic field as well as the angle between the direction of the magnetic field and the gravitational force can be taken into consideration. A reference value can be measured by the robot, for example, during a special exploratory run during its initial operation.

It is possible, by means of a user entry, to switch between the representation of the map data with a fixed orientation and a representation in which the orientation changes in response to the rotation of the HMI. In the case of three-dimensional maps, at least one preferred direction can be determined based on the direction of the gravitational force. This makes it possible to display the map data according to the orientation of the gravitational force. For example, a representation of the three-dimensional map data comparable to a floor plan is shown when the HMI (especially its screen) is essentially horizontally (parallel to the earth's surface) with the display direction pointing upward (i.e., the normal vector of the screen is essentially antiparallel to the gravitational force). When the HMI is held at an angle, a perspective representation of the three-dimensional map data can be selected, which is determined based on the angle of inclination of the HMI to the gravitational force (e.g., angle between the normal vector of the screen and the gravitational force).

When using three-dimensional map data, two (linearly independent) preferred directions such as the direction of the gravitational force (Earth's gravity) and the geomagnetic field can be used. This makes it possible to define an external coordinate system (independent of the robot), which is easy to determine.

It should be noted that, when determining the preferred direction based on magnetic field measurements in an HMI and in a robot, the best results with respect to the comparability of the two preferred directions are obtained if the measurements are conducted at approximately the same height. In sufficiently tall robots (e.g. telepresence robots), this is achieved by installing the magnetometer at a height of about 1 m to 1.5 m. This is usually not possible in cleaning robots, as they are built with heights of around 10 cm such that they can clean underneath pieces of furniture. In most cases, however, the accuracy achieved in determining the preferred direction is sufficient.

Simplified self-localization—An essential prerequisite for the permanent use of map data of the robot deployment area by the autonomous mobile robot is the ability of the robot to reliably determine its own position in an already existing map of the robot without (or with only little) prior knowledge. This capability is called (global) self-localization and is required, for example, when the robot has been completely switched off or moved to a new location by a user. For this purpose, it is advantageous if the determined preferred direction M is stored permanently along with the map data (e.g., as an attribute of the robot deployment area covered by the map, or a part thereof) in order to use it for simplifying and thus improving the self-localization.

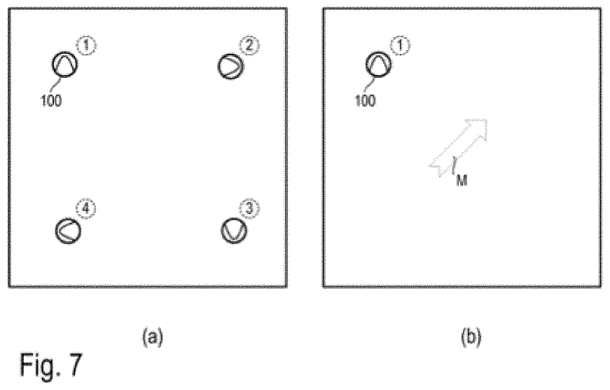

During the self-localization, the robot uses its sensors (see FIG. 2, sensor unit 120) to collect sensor data representing its environment in the robot deployment area, and tries to determine its position (incl. orientation) in the map of the robot deployment area based on the information contained in the sensor data. If the robot 100, in addition to the sensor data used for navigation (e.g., camera images, distance measurement to obstacles) of the sensor unit 120, can collect information for determining the preferred direction, for example with the help of the magnetometer (e.g., FIG. 2, sensor unit 130), the complexity of the self-localization task is significantly reduced by limiting the degree of freedom of the rotation. This is intended to be illustrated by the example in FIG. 7. In a square room with no further distinguishing features, it is impossible to determine the position of the robot without prior knowledge, since the space is symmetrical with respect to a rotation of 90°. As shown in diagram (a) of FIG. 7, this leads to four equivalent possible positions (1, 2, 3, 4) including associated orientations of the robot; it is impossible without further information (without objective orientation characteristics) for the robot to distinguish the four positions from diagram (a) of FIG. 7; an unambiguous self-localization is impossible.

As shown in diagram (b) of FIG. 7, the aforementioned symmetry with regard to orientation is eliminated by providing the additional information of the preferred direction, whereby an exact self-localization is made possible. This applies as long as this preferred direction is determined with an accuracy higher than ±45°. Thus, a comparatively high measurement accuracy of the preferred direction is not a limitation for the approach to self-localization described here. As described above, the accuracy with which the preferred direction can be determined can be detected during the map generation and the initial determination of the preferred direction.

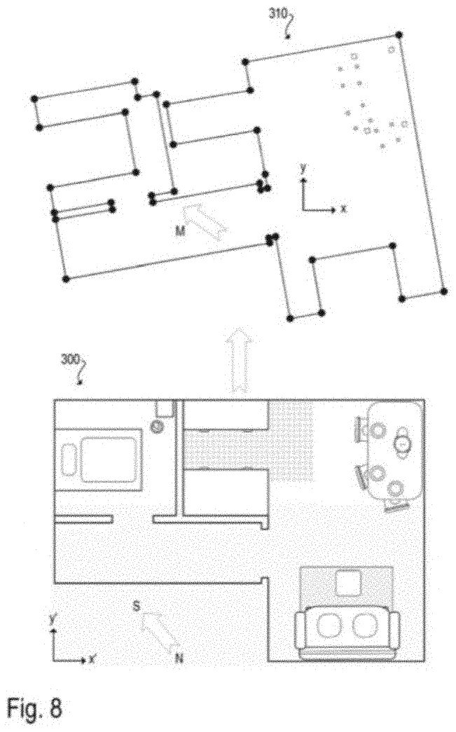

Comparison with a map predefined by the user—Plans (particularly in the form of floor plans) are often available for a user's dwelling, which plans indicate a room layout and use of the space. These are usually designed such that they are easily comprehensible to a user. On the other hand, navigation maps created by a robot are usually difficult to understand, as the landmarks and obstacles (navigation features) used for the robot's navigation do not have to have the same relevance to the user, as robot and user usually orient themselves at different heights. Due to the low height of a cleaning robot, for example, only the legs of a table are relevant for it, not the entire table. The robot does not “see” the tabletop at all. Since both (dwelling plan/floor plan and robot map) contain information about the same environment, they can in principle be merged and used for a better comprehensibility in the human-robot interaction. An example of merging two maps is shown in FIG. 8.

For this purpose, the user will provide the robot with an electronic form of the dwelling plan via an HMI (e.g., in a common graphic format as pixel graphics or vector graphics). The HMI can send the graphic file with the dwelling plan 300 directly to the robot 100 (cf. wireless transmission according to FIG. 2). Considering the limited computing capacity of an autonomous mobile robot 100, the dwelling plan 300 can also be sent to a cloud service, such as a server accessible via the Internet, to perform the necessary calculation. The server accessible via the Internet has access to all necessary map data generated by the robot 100 (see FIG. 8, robot map 310), or receives the same from the robot. The outsourcing of computing power from the robot can in this sense be regarded as a virtual extension and thus part of the autonomous mobile robot (e.g. as an outsourced part of the control unit 150, cf. FIG. 2). Pattern recognition methods (pattern matching) can be used to automatically determine a relationship between the dwelling plan and the robot map. For example, algorithms can be used that are also used for self-localization. For example, machine learning methods such as neural networks, especially deep learning, can be used.

The aforementioned relationship between dwelling plan 300 and robot map 310 can be a mathematical coordinate transformation to convert coordinates (x′, y′) referring to a coordinate system of the dwelling plan 300 into coordinates (x, y) referring to a coordinate system of the robot map 310. However, it may also be sufficient to copy individual pieces of information from the dwelling plan into the robot map. For example, the topological structures of the dwelling (i.e., the robot deployment area) can be analyzed based on the dwelling plan 300. This describes, for example, which rooms are present in the dwelling and how they are connected via doorways or separated by walls. The robot map can then be analyzed to assess if and how this topological structure can be found in it. This is done, for example, by means of an automatic partitioning of the robot map into rooms and its adaptation to the room layout of the dwelling plan. Based on this room layout, information such as room labels and usage can be transferred from the dwelling plan 300 to the robot map 310.

As mentioned above, the user can provide the robot 100 with a map in electronic form, from which the robot 100 can generally extract information and use it to create or complement its own map. The map provided by the user could be, for example, a simple hand sketch of the floor plan of a dwelling (the robot deployment area). From this hand sketch, the robot can extract topological information about the room layout (approximate shape, size and location of the rooms, and the connections between the rooms), for example, and use this information to determine how to partition its own map into individual rooms. The hand sketch could also contain larger pieces of furniture, which the robot 100 cannot recognize as such (for example, a cabinet and a wall both equally are obstacles for the robot and cannot always be distinguished).

A dwelling plan, especially in the form of a floor plan, often contains information about the orientation of the represented dwelling in a north-south direction. By determining the preferred direction M based on magnetic field measurements by the robot 100, this north-south orientation can be identified (see FIG. 3, preferred direction M in robot map 310). This greatly simplifies the determination of a relationship between the dwelling plan 300 and the robot map 310, since the degree of freedom of rotation is significantly reduced. Furthermore, this requires a comparatively low accuracy for the concordance between the preferred direction determined by the robot and the north-south orientation recorded in the plan 300. In fact, the preferred direction can serve as a first estimate, which is improved with further methods of pattern recognition. For example, an exact alignment of the robot map with the dwelling plan can be determined on the basis of the shape of the obstacles, in particular of the walls.

The advantage of this procedure arises from the fact that a dwelling usually is constructed with essentially parallel and orthogonal walls. An analysis of the shape of the walls thus leads to four main directions. By determining the preferred direction M, this multiplicity is eliminated in a simple manner (much like during the self-localization according to FIG. 7).

Exchange of maps between robots—In some situations, it may be desirable for a new (second) robot to work with a map that it has not generated, or only partially generated. In this case, the second robot can receive the map from the first robot and use it. For example, a robot can be designed to permanently navigate with a map and to use it for user interaction. Such a map may have been personalized, for example, by labeling rooms and entering user-specific sections, which involved a considerable expenditure of time by a user. If a new, second robot is to be used in this already mapped robot deployment area (e.g., because the first robot is being replaced or supplemented), it is significantly easier for the user if the map data of the first robot can be transferred to the second robot.

Herein, the problem arises, for example, that the maps of two robots can differ due to differences in sensor technology. For example, the two robots can have different sensors, such that at least portions of the environment are detected differently. For example, a new robot can contain improved sensors, which can be used, for example, to determine distances to obstacles or, for example, the movement of the robot (e.g., by means of odometry), such that the position of the obstacles in the map as well as the position (incl. orientation) of the robot relative to the map are detected more accurately. Alternatively or additionally, a new robot may have sensors (e.g., included in the sensor unit 120, cf. FIG. 2) which collect new, previously undetectable information in addition to the characteristics of the environment (landmarks and/or obstacles) previously used for navigation. For example, a distance measurement sensor can be expanded in a horizontal plane in a new robot, such that distances are detected outside of said plane, thus capturing a three-dimensional image of the environment (e.g., using a 3D camera). In another variant, an existing optical sensor for distance measurement can be complemented by an ultrasound sensor, which can better detect transparent or reflective objects.

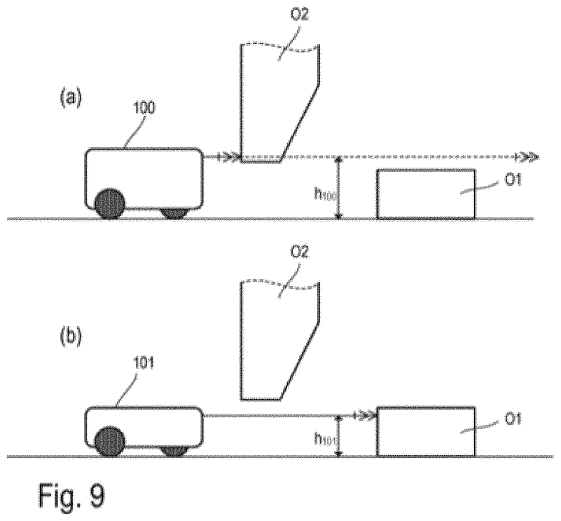

It is also possible that the two robots have the same sensors in different arrangements, such that at least portions of the environment are detected differently. FIG. 9 shows examples of two robots 100 and 101 with a sensor system (e.g., included in sensor unit 120, cf. FIG. 2) for distance measurement in a horizontal plane (parallel to the floor surface) of the same design (e.g., scanning with a laser distance gauge). However, due to the different height of the robots 100, 101 (or due to different installation heights of the sensors), the planes in which the distances are measured are located at different (vertical) distances h100 or h101 to the floor surface. As a result, the taller robot 100 may not detect low obstacles O1, but detect obstacles O2 hanging down from above (see diagram (a) in FIG. 9). Conversely, the short robot 101 can't detect hanging obstacles O2, but can detect low obstacles O1 (see diagram (b) in FIG. 9). As a result, the robots 100, 101 use different obstacles for orientation and the respective maps they use may differ.

There may be differences in the maps even in robots of the same design with the same sensors, which differences are due to differently calibrated sensors and the associated differences in measurement accuracy (e.g., due to manufacturing tolerances). For example, a distance measurement sensor may have a systematic deviation of 5% or 10%, which directly affects the map thus generated. The algorithms used for mapping and navigation can be designed to be less prone to such systematic errors, since the measured distances and the distances recorded in the map are largely the same. However, a problem arises in the case of a transition from a systematic error (e.g., −5%) by a sensor of a first robot to another systematic error (e.g., +5%) by a sensor of a second robot, as the measured distances may no longer match the distances recorded in the map.

Consequently, the position of an obstacle and/or landmark determined by the robot will deviate from the position stored in a map adopted from another robot and must be corrected accordingly. In addition, new obstacles and/or landmarks that are not recorded in the adopted map can be detected. The other robot possibly may not “see” individual obstacles and/or landmarks recorded in the adopted map.

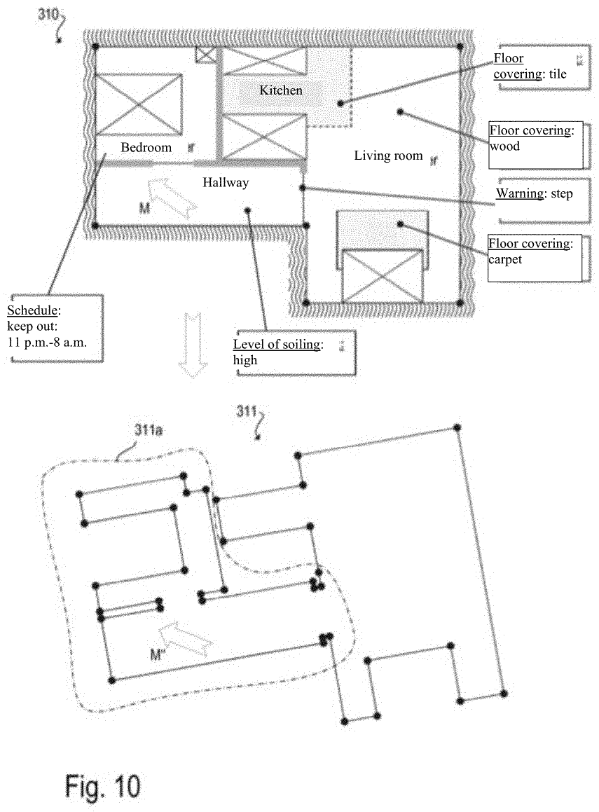

As a result, it is much more difficult to determine the position of a robot in a map that was not originally determined by the respective robot. Therefore, it is necessary for the new robot to create a new map in which the positions of the obstacles and/or landmarks are adapted to the sensors of the new robot. In this context, the information of the first map should be used, in particular to maintain the information entered and/or confirmed by the user. The new map thus obtained, which in particular also contains the information entered by the user, can be saved permanently and can be used by the new robot both for user interaction and for navigation in subsequent robot deployments. An example is shown in FIG. 10. FIG. 10 shows a map 310 of the robot 100, which has already been edited (provided with attributes) and confirmed by the user. Such attributes may include, for example: Labeling of the rooms (e.g., “hallway,” “bedroom,” “living room,” “kitchen,” etc.), schedules (e.g., “keep out from 11 p.m. to 6 a.m.”), information regarding the degree of soiling (e.g., usually high level of soiling in the hallway, robot cleans more frequently), information regarding the flooring (e.g. “wood floor,” “tiles,” “carpet,” etc.), preferential direction M, warnings (e.g., “stairstep,” robot moves slowly), etc. In the map 311 newly generated by the new robot 101, these attributes entered and/or confirmed by the user are missing. These can be automatically transferred from the map 310 to the map 311.

The resulting new map 311 (with the additional information transferred from the map 310) can be submitted to the user for confirmation, such that the user can review whether the information transfer was performed correctly. If necessary, the user may correct and/or update the data before the map generated in this manner is permanently stored. Mapping the information contained in the two maps can be greatly simplified if a preferred direction M has been determined for the map from the first robot, for example by measuring the magnetic field. The second robot 101 can also determine the preferred direction M″ and thereby detect the orientation of its map 311 (relative to the map 310 of the robot 100). Furthermore, this requires a comparatively low accuracy for the concordance between the preferred direction M″ determined by the robot 101 and the preferred direction M recorded in the map 310. In fact, the orientation based on the preferred direction can serve as a first estimate, which is improved with further methods of pattern recognition and, in particular, of self-localization.

In a simple variant, the new robot 101 creates a map (e.g., map 311, see FIG. 10) during a learning run or during a first operational deployment (e.g., complete cleaning of the deployment area/dwelling), which is used temporarily. The new robot map of the robot 101, which map is to be used permanently, is generated by combining the temporary map 311 with the map 310 to be adopted from another robot (e.g., robot 100). For example, a transformation between the coordinates of the temporary map 311 and the coordinates of the map 310 is generated based on the obstacles and/or landmarks detected during the learning run and recorded in the temporary map 311 and the obstacles and/or landmarks recorded in the map 310. The transformation can consist of rotation, translation, and scaling, for example. This coordinate transformation can be used to add information such as room layout and section boundaries, room labels, or user-defined areas, as well as schedules and the like from the map to be adopted to the temporary map. It should be noted that a partial creation of the temporary map 311 is sufficient to determine the transformation, and that no complete exploration is necessary. For example, just one room of a dwelling can be explored and compared with the previously established map 310. The user can specify which room is being explored, for example. In the example shown in FIG. 10, the left part of the map 311 is marked as an unexplored area 311a. The transfer of the map information from the map 310 can be performed before the robot 101 has explored the area 311a, because enough data is available after the right part of the map 311 is created to perform the aforementioned transformation. For example, the user can transmit a starting point or a room in which the starting point is located to the robot, and/or a room to be newly explored by the robot can be automatically suggested to the user based on the existing map 310. In this case, the robot “knows” from the outset in which room it is located, and the self-localization in the new map is simplified (by reducing the possibilities).

In an alternative variant, the new, second robot 101 already uses the map 310 to be adopted (e.g., received from the robot 100) for navigation during the learning run or during a first operational deployment. This means that the robot 101, for example, is aware of hazardous areas (i.e., areas that can impair the functioning of the robot, such as stairs, cables, etc.) recorded in the map 310 to be adopted, and can avoid them. In addition, having this prior knowledge makes it possible to create a map significantly faster. This process makes use of the robot's ability to recognize the obstacles/landmarks, which is required for robust robot navigation, and, if necessary, to correct their position, shape and/or size in the map, to add newly detected obstacles/landmarks to the map, and to delete obstacles/landmarks from the map that do not exist (any longer). The usability of the “old” map 310 by the robot 101 can be increased if the maps 310 and 311 can be aligned according to the corresponding (stored or newly determined) preferred direction. Alternatively or additionally, the orientation of the maps can be improved or simplified if the robot 101 is started from a defined, known position (e.g., from the base station 110) before the creation of the new map 311.

For example, probabilistic SLAM procedures can be used to determine the probabilities for the position of obstacles/landmarks. For example, the expected value, standard deviation, and correlation between the positions of the obstacles/landmarks are determined and stored in the robot's map. For example, in order to easily make a map to be adopted usable for a new robot with the same or similar sensors, the positional uncertainty of the obstacles recorded in the map can be increased. For example, the stored standard deviation can be increased (e.g., by multiplying by a selectable constant, such as 2) and the correlations can be decreased (e.g., by multiplying by a selectable constant, such as ½). During the learning run or during an initial operational deployment, the probability distributions of the positions are updated according to the measurement values from the new sensors. For example, the expected value, standard deviation, and correlation between the positions of the obstacles/landmarks are updated and stored.

Based on the corrections of recognized obstacles/landmarks, the information obtained based on a user input can also be corrected. For example, it can be ascertained that the measured distance between two obstacles has increased (e.g., due to an improved measurement accuracy of the sensors). For example, the position of a user-defined area boundary extending between the two obstacles can be corrected such that the ratio of the distances to both obstacles remains constant. The labels entered by the user, e.g., for obstacles, areas or rooms, herein are preserved naturally.

In addition to the information to be measured directly, which is used directly for navigating (in particular obstacles and/or landmarks), a map also contains derived information. For example, a detected (or learned) hazardous area such as a door threshold/step (see FIG. 10) or a drop-off edge (e.g., in a stairway), from which the robot can fall and which should therefore be carefully navigated or avoided by the robot, may be included in the adopted map data. For example, a room layout can be generated automatically based on the detected environment, and saved in the adopted map. Such derived information may be newly created or treated as information entered by a user.

Improvement of docking to a base station—An autonomous mobile robot usually is associated with a base station (see FIG. 1, base station 110), where the robot can charge its battery, for example. For cleaning robots, base stations are known where dirt can be unloaded, or cleaning fluids can be refilled.

Various procedures are known for how the robot recognizes its base station and plans a docking path to it. If the robot uses a map of its environment for navigating, the location of the base station may be recorded in the map. The robot can thus plan a path to the vicinity of the base station at any time, such that it can detect it with a sensor and determine a concrete docking path.

Various methods are known for recognizing the base station. For example, the base station can emit a signal in the form of infrared radiation, which the robot detects with a sensor such as a camera or a photodiode and then follows the signal to its source. Other systems use the navigation sensor, which collects information about the environment, to recognize the base station by a marker or directly by its shape. Thus, the navigation sensor can be a camera in whose captured image the base station and its position can be detected, or which recognizes a specific pattern attached to the base station (e.g., a QR code). The navigation sensor can also be a distance measurement sensor that can be used to determine the distance to obstacles. The shape of obstacles can be determined from the distance information and thus the base station can be recognized, for example, by its specific shape.

Once the base station has been detected and its position has been determined relative to the robot, the robot can determine a docking path for performing a docking maneuver, and be steered and controlled accordingly. Since control commands are usually not executed exactly, but are subject to errors, the position determination of the base station and an adjustment of the docking path are repeated at appropriate intervals. A problem in this context may be that the navigation sensor requires a minimum distance to reliably determine the position of the base station. For example, a camera may not provide sharp images at close range, or measuring the distance may require a minimum distance to the sensor to reliably measure distances or to recognize a sufficiently large area of the base station. The robot thus travels the final portion of the docking path without additional monitoring. Especially in the case of a poor surface, such as carpet, on which the wheels of the robot have a high slip, this can cause the docking to the base station to fail. In many cases, the navigation sensor is designed to collect information over longer distances. This usually goes hand in hand with the fact that no or only limited information (especially about the base station during the docking maneuver) is collected close up (e.g., incorrect/lacking focus on a camera). In these cases, the robot must travel “blind” for the last few centimeters of the docking path (i.e., in proximity to the base station).

This can be avoided if the base station has a marking with which the position of the robot relative to the base station can be reliably determined at close range. This marking can be created, for example, by generating a magnetic field, which the robot can measure with the help of a magnetometer. Specifically, the magnetic field can be generated by permanent magnets. Alternatively or additionally, electromagnets can be used. Permanent magnets have the further advantage that the robot, by measuring the magnetic field, can detect whether it is positioned on the charging station or not, regardless of whether a charging voltage is present at the charging contacts. In this way, the robot can detect that it is positioned at the base station, in particular including in the event of a power failure. This situation is represented in FIG. 11. Diagram (a) in FIG. 11 shows an exemplary perspective view of a base station 110 with charging contacts 111 and a magnet 112. Diagram (b) shows the corresponding top view. The magnet 112 does not have to be arranged in the center of the base station. The magnet may also be arranged asymmetrically in the base station 110, for example, such that it is positioned opposite to a magnetometer arranged asymmetrically in the robot (cf. FIG. 3, diagram (c)) when the robot is docked.

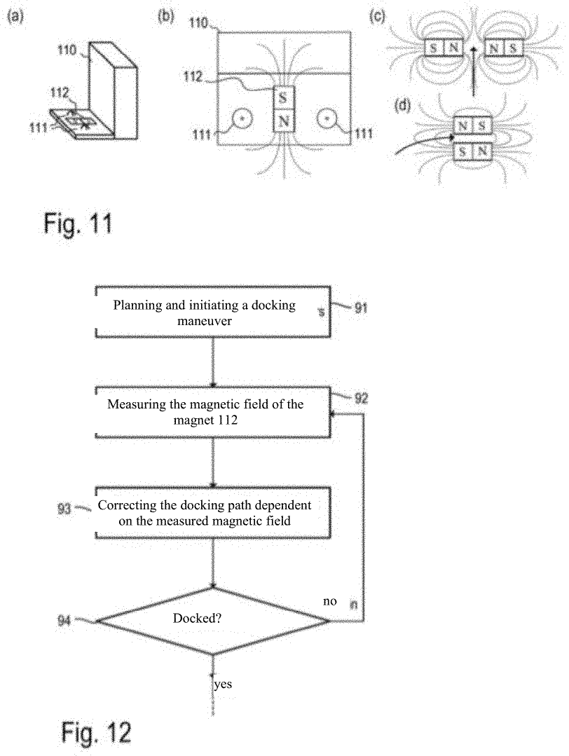

A single magnet such as magnet 112 in FIG. 11, in diagram (a), creates a dipole field. This means that the magnetic field has a characteristic direction and value at every location in front of the base station. This information makes it possible, in principle, to determine the position (and orientation) of the robot relative to the magnet and thus relative to the base station. In addition, the magnetic field and/or the change of the magnetic field can be detected during a docking maneuver. This allows additional position information to be obtained. Based on the position (and orientation) thus determined, an incorrect execution of the docking path can be detected and corrected. This correction of the currently executed docking path is particularly useful in the immediate vicinity of the base station, where the navigation sensor (see FIG. 2, sensor unit 120) can be “blind” or provides only very inaccurate information. FIG. 12 shows an example of a docking procedure. First, a docking path for a docking maneuver is planned in a conventional way (e.g., map-based) (FIG. 12, step 91). For this purpose, the pose of the base station 110 relative to the robot 100 is usually determined by means of a navigation sensor (cf. FIG. 2, sensor unit 120). During the docking maneuver, the magnetic field is measured with a magnetometer (e.g., as part of the sensor unit 130), which is generated by the magnet 112 (cf. FIG. 11) at the base station 110 (FIG. 12, step 92). Based on these measurements of the magnetic field, the robot 100 can continuously monitor its docking path and, if necessary, correct it (FIG. 12, step 93). The continuous monitoring and correction of the docking path is performed in the vicinity of the base station 110 until the robot has successfully docked (FIG. 12, step 94). Alternatively, it may be desirable that the robot 100 should dock to the base station in reverse, while the navigation sensor (cf. FIG. 2, sensor unit 120) is directed forward. In this case, the robot 100 does not “see” the base station 110 during the docking maneuver. In this case, the aforementioned magnetic field measurements are particularly useful for monitoring and correcting the docking maneuver.

Other magnets can be used to influence the characteristic shape of the magnetic field and thus improve the accuracy of the position determination based on measuring the magnetic field. Examples are shown in diagrams (c) and (d) in FIG. 11. For example, two magnets can be combined to create a quadrupole field. The combination of several magnets has the additional advantage that the range of the generated magnetic field and thus the interference in the environment by the magnetic field is reduced. For example, the field strength of a quadrupole field decreases four times faster than the field strength of a dipole field. Thus, locally significantly higher field strengths can be used and thus measured reliably without interfering with the environment. In the example in diagram (c) of FIG. 11, two opposite-oriented magnets are aligned along an axis. In this case, the robot could approach the base station, for example, along the field lines towards the magnetic north. In diagram (d) of FIG. 11 two magnets are arranged antiparallel. In this case, the robot can approach the base station along the strongest increase in field strength, for example. The respective possible paths of the robot are marked with an arrow. In both cases, the magnetic field changes greatly in strength and direction within short distances, thus enabling a comparatively accurate localization. The field strength drops rapidly, such that an influence on the environment (and in particular the determination of the preferred direction) is reduced or stronger magnets can be selected.

1. A method for an autonomous mobile robot, comprising the following:
Detecting information regarding the structure of the environment around the robot in the robot deployment area by means of a first sensor unit of the robot and creating a map based on the detected information;
Measuring a direction and/or absolute value of at least one physical vector field variable for one or more poses of the robot by means of a second sensor unit;
Determining, based on the measurements taken for one or more poses of the robot, a preferred direction of at least one physical vector field variable for the robot deployment area or part of it.

2. The method according to claim 1, which further comprises:
Storing the determined preferred direction in the map;
Sending the map to a human-machine interface; and
displaying the map by means of the human-machine interface, taking into consideration the preferred direction determined by the robot of the at least one physical vector field variable.

3. The method according to claim 2, which further comprises:
Measuring a physical vector field variable by means of at least one sensor in the human-machine interface;
Determining the orientation of the human-machine interface based on measurements related to the environment; and
Considering the specific orientation of the electronic device when displaying the map.

4. The method according to claim 2, which further comprises:
Receiving map-based user input via the human-machine interface; and
Sending a control command dependent on the user input to the robot.

5. An autonomous mobile robot having the following:
a drive unit for moving the robot within a robot deployment area;
a first sensor unit for collecting information about the structure of the robot's environment in the robot deployment area;
a second sensor unit for measuring a direction and/or absolute value of at least one physical vector field variable at one or more poses of the robot; and
a control unit designed for configured to:
navigating the robot in the robot deployment area based on the information provided by the first sensor unit about the structure of the environment in the robot deployment area and a map of the robot deployment area, and
determine, based on the measurements of the at least one physical vector field variable performed with the second sensor unit at one or more poses of the robot, a preferred direction of said poses in the robot deployment area or a part of it.

6. (canceled)

7. (canceled)

8. The autonomous mobile robot according to claim 5, wherein the determination of the preferred direction is based on at least two measurements at different poses of the robot.

9. The autonomous mobile robot according to claim 5,
wherein the determination of the preferred direction is based on multiple measurements, which are performed at one specific position, but different orientations of the robot.

10. The autonomous mobile robot according to claim 5,
wherein the determination of the preferred direction uses measurement values based on at least one first measurement and one second measurement, wherein the robot assumes the opposite orientation in the first measurement as it does in the second measurement.

11. The autonomous mobile robot according to claim 5,
wherein the control unit is configured to calculating a value representing the accuracy, in particular a variance or standard deviation, for the determined preferred direction.

12. The autonomous mobile robot according to claim 5,
wherein the control unit is designed configured to:
store the determined preferred direction in the map;
reload the stored map, including the associated preferred direction, at a later time; and perform a global self-localization of the robot in the map, wherein the preferred direction stored in the map and one or multiple measurements performed by the second sensor unit are taken into consideration.

13. The autonomous mobile robot according to claim 5,
wherein the control unit is configured to:
receive a map of the robot deployment area from an external device by means of a communication unit, wherein the received map contains information about a preferred direction; and
to determine the orientation of the received map relative to a map created by the robot based on the preferred direction of the received map and the determined preferred direction.

14. (canceled)

15. The autonomous mobile robot according to claim 12,
wherein the control unit is configured to:
transfer information from the received map to the map generated by the robot, in particular information regarding a partitioning of the map into sections, labeling the sections, further information regarding the sections.

16. A system comprising the following:
an autonomous mobile robot having the following:
a drive unit for moving the robot within a robot deployment area;
a first sensor unit for collecting information about the structure of the robot's environment in the robot deployment area;
a second sensor unit for measuring a direction and/or absolute value of at least one physical vector field variable at one or more poses of the robot; and
a control unit configured to:
navigate the robot in the robot deployment area based on the information provided by the first sensor unit about the structure of the environment in the robot deployment area and a map of the robot deployment area, and
determine, based on the measurements of the at least one physical vector field variable performed with the second sensor unit at one or more poses of the robot, a preferred direction of said poses in the robot deployment area or a part of it;
a communication unit;
an electronic device, wherein the robot is designed to communicate with the electronic device by means of the communication unit;
wherein the electronic device is designed to receive the map of the robot deployment area as well as the associated preferred direction from the robot.

17. The system according to claim 16,
wherein the electronic device is a human-machine interface, which is configured to display the map received from the robot, taking into consideration the preferred direction.

18. (canceled)

19. (canceled)

20. A method comprising the following:
Transferring a first map of a robot deployment area to an autonomous mobile robot;
Detecting information about the structure of the environment in the robot deployment area by means of a sensor unit of the robot;
Creating a second map of the robot deployment area or part of it that allows the robot to navigate the robot deployment area, based on the information collected about the structure of the environment and the first map.

21. The method according to claim 20,
wherein the first map is associated with a preferred direction of at least one physical vector field variable in the robot deployment area or part thereof;
wherein the method further comprises measuring a direction and/or absolute value of at least one physical vector field variable at one or multiple poses of the robot, and determining a preferred direction of at least one physical vector field variable for the robot deployment area or part thereof that can be associated with the second map; and
wherein the orientation of the first map relative to the second map is determined based on the preferred directions associated with the maps.

22. The method according to claim 20, which further comprises:
Determining an allocation of position information of the first map relative to position information of the second map, in particular a coordinate transformation, using methods of image processing and/or methods of global self-localization and/or methods of pattern recognition.

23. The method according to claim 202,
wherein information from the first map is adopted into the second map, and/or the second map is updated based on information from the first map.

24. The method according to claim 23,
wherein the information from the first map relates to at least one of the following: a partitioning of the robot deployment area into sections; labeling of the sections; characteristics of sections, in particular floor covering in sections, restricted areas, schedules and tasks for robot deployments; information based on user input.

25. The method according to claim 20,
wherein the first map of the robot deployment area was created by a further autonomous mobile robot, in particular such that the further robot is able to navigate the robot deployment area using this first map.

26. The method according to claim 25,
wherein the robot, in order to create the second map, determines its position with respect to the first map and updates the map data of the first map, in particular the positions of navigation features, by means of the information collected by the sensor unit about the structure of the environment in the robot deployment area.

27. The method according to claim 20,
wherein the robot performs a task during the creation of the second map, in particular treating a floor surface in the robot deployment area.

28. The method according to claim 20,
wherein information from the first map is used to generate and/or complement new map data for the second map.

29. The method according to claim 20, further comprising:
Transferring the second map to an HMI;
Displaying the information adopted from the first map on the HMI, in particular the information based on a previous user input; and
Receiving a confirmation, deletion and/or correction of the adopted information by the user.

30-37. (canceled)
